(19) United States
(12) Patent Application Publication
(10) Pub. No.: US 2022/0358847 A1
(43) Pub. Date: Nov. 10, 2022

(54) METHOD AND APPARATUS FOR RUNWAY OVERRUN AVOIDANCE FUNCTION FOR PILOT DEFINED CUSTOM LANDING SURFACE

(71) Applicant: HONEYWELL INTERNATIONAL INC., Charlotte, NC (US)

(72) Inventors: Muthusankar Subramaniyan, Brno (CZ); Ari Narayanan M, Madurai (IN); Gobinathan Baladhandapani, Madurai (IN); Hariharan Saptharishi, Madurai (IN); Sivakumar Kanagarajan, Bangalore (IN)

(73) Assignee: HONEYWELL INTERNATIONAL INC., Charlotte, NC (US)

(21) Appl. No.: 17/304,676

(22) Filed: Jun. 24, 2021

(30) Foreign Application Priority Data
May 7, 2021 (IN) 202111020817

(51) Int. Cl. G08G 5/02; G08G 5/00; B64D 45/04; G06F 16/29

(52) U.S. Cl. CPC G08G 5/025; G08G 5/0021; B64D 45/04; G06F 16/29

(57) ABSTRACT

Methods and systems are provided for runway overrun alerts for an aircraft using manually entered parameters for a non-standard runway. The method includes accessing an interface for an enhanced ground proximity warning system (EGPWS). The following parameters are then manually entered: identification of the non-standard runway; a displaced threshold of the non-standard runway; surface conditions of the non-standard runway; a declared length of the non-standard runway; and availability of thrust reversers on the aircraft. The parameters for the aircraft to safely land and stop on the non-standard runway are calculated with the EGPWS. An alert with the EGPWS is generated if the stopping point of the aircraft is near or beyond the end of the non-standard runway.

### CROSS REFERENCE TO RELATED APPLICATION

This application claims priority to Indian Provisional Patent Application No. 202111020817, filed May 7, 2021, the entire content of which is incorporated by reference herein.

### TECHNICAL FIELD

The present invention generally relates to aircraft operations, and more particularly relates to generating runway overrun alerts for an aircraft using entered parameters for a custom runway.

### BACKGROUND

Runway overruns during landing have been widely recognized as one of the highest operational risks in commercial aviation and are a major contributor to airplane accidents worldwide. For landing overruns, the top contributing factors identified are: go-around not conducted; ineffective braking (contaminated runway, fast/high approach, etc.); long/fast/hard/bounced touchdown; and inadequate glideslope/altitude/speed control. However current the current Runway Overrun Awareness and Alerting System (ROAAS) functions for the runways previously defined in a navigational database. Hence, there is a need for generating runway overrun alerts for an aircraft using manually entered parameters for a custom runway.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for providing runway overrun alerts for an aircraft using manually entered parameters for a non-standard custom runway. The method comprises: accessing an interface for an enhanced ground proximity warning system (EGPWS) and entering necessary data for the non-standard custom runway necessary to determine the landing parameters to safely land and stop the aircraft; calculating the landing parameters for the aircraft to safely land and stop on the non-standard custom runway with the EGPWS; and generating an alert with the EGPWS if the stopping point of the aircraft is near or beyond the end of the non-standard custom runway.

An apparatus is provided for providing runway overrun alerts for an aircraft using manually entered parameters for a custom runway. The apparatus comprises: a graphical user interface (GUI) that allows a pilot to access an enhanced ground proximity warning system (EGPWS) and manually enter, identification of the custom runway, a displaced threshold of the custom runway, surface conditions of the custom runway, a declared length of the custom runway, and availability of thrust reversers on the aircraft; an enhanced ground proximity warning system (EGPWS) that calculates the parameters for the aircraft to safely land and stop on the custom runway; and a primary flight display (PFD) that shows an alert from the EGPWS if the stopping point of the aircraft is near or beyond the end of the custom runway.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a diagram of a system for providing runway overrun alerts for custom runways in accordance with one embodiment;

FIG. 2 shows a block diagram of a system for providing runway overrun alerts for custom runways in accordance with one embodiment;

FIG. 3 shows a system architecture diagram of a system for providing runway overrun alerts for custom runways in accordance with one embodiment;

FIG. 4 shows a diagram of an algorithm for a system for providing runway overrun alerts for custom runways in accordance with one embodiment;

FIGS. 5A and 5B show displays for manually entering parameters for a custom runway in accordance with one embodiment;

FIGS. 6A-6F show displays for indicating the approach and landing parameters for an aircraft to a custom runway in accordance with one embodiment; and

FIG. 7 shows a flowchart depicting a method for providing runway overrun alerts for an aircraft using manually entered parameters for a custom runway in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Methods and systems have been developed for generating runway overrun alerts for an aircraft using manually entered parameters for a custom runway. The method includes accessing an interface for an enhanced ground proximity warning system (EGPWS). The following parameters are then manually entered: identification of the custom runway; a displaced threshold of the custom runway; surface conditions of the custom runway; a declared length of the custom runway; and availability of thrust reversers on the aircraft. The parameters for the aircraft to safely land and stop on the custom runway are calculated with the EGPWS. An alert with the EGPWS is generated if the stopping point of the aircraft is near or beyond the end of the custom runway.

The Runway Overrun Awareness and Alerting System (ROAAS) provides alerts indicating to the crew of a potential overrun condition. To determine if there is enough distance and runway available for the aircraft to safely land and stop, the ROAAS algorithm computes the estimated approach and stopping distances and compares this to the available remaining runway. If it is determined that the stopping point is near or beyond the runway end based on current aircraft and runway conditions, then ROAAS alert is generated. The ROAAS alerts may be of visual alert display on the primary flight display (PFD) and/or a corresponding aural or haptic alert.

Per Federal Aviation Administration (FAA) statistics, there are approximately 14,400 private-use (i.e., closed to the public) and 5,000 public-use (i.e., open to the public) airports, heliports, and seaplane bases. In general aviation, aircraft usually land in the private airfields and grass airfields. Many of these “non-standard” runways (i.e., custom runways) lack parameters in a database that may be used by the ROAAS.

Custom runways are sometimes referred to as pilot-defined runways. Custom runways give the pilot some additional flight planning capabilities, beyond just entering a runway specified in a Navigational Database (NavDB). The pilot may want to specify a custom runway as the origin and/or destination. Pilots may define the custom runways through the unique graphical interface. When the Pilot enters a non-standard custom runway as the destination, FM TOLD function sends the following parameters are sent to EGPWS who hosts the ROAAS: custom runway identification and attributes; displaced threshold; surface condition (may be tailored for the custom runway); destination runway declared length; and aircraft thrust reverser availability if selected in the appropriate crew interface.

A key feature is in the ability to add the surface condition for the custom runways. Runway condition is one of the important attributes in computing the overrun alerts. Another key feature of this embodiment is the ability to customize the definition of the various attributes for the custom runways. The custom runway information may be stored in the custom database. Current ROAAS function communicates with the NavDB but typically not with custom DBs. Due to the increase use of advanced connectivity technologies, there is the ability to use custom databases based in cloud and also the custom databases located on the aircraft itself. In some embodiments, the custom databases may be used by in common across all airline fleets.

As used herein, charts may be any aviation chart or aeronautical chart provided as an informational aid to a flight crew for flight planning purposes. Chart data is any data provided by an electronic chart or a data driven chart (DDC). Aircraft generally use electronic charts for providing a flight crew member with information specific to a particular route and/or airport. Electronic charts may include airport maps; intersections and taxiways data; procedures and data associated with approach, arrival, and departure; and any flight constraints associated with a current flight plan. A flight plan is a proposed strategy for an intended flight, includes details associated with the intended flight, and is usually filed with an aviation authority (e.g., Federal Aviation Administration). An intended flight may also be referred to as a “trip” and extends from a departure airport at the beginning point of the trip to a destination airport at the endpoint of the trip. An alert may be any signal or warning indicating potential non-compliance with constraints associated with the current flight plan. The alert may be implemented as a display of text and/or graphical elements, a sound, a light, or other visual or auditory warning signal onboard the aircraft.

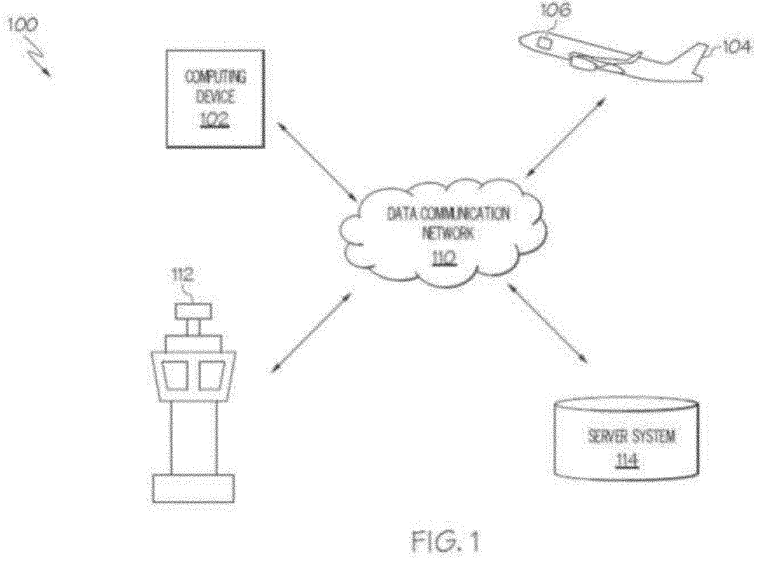

Turning now to the figures, FIG. 1 is a diagram of a system 100 for providing runway overrun alerts for custom runways in accordance with the disclosed embodiments. The system 100 operates with a current flight of the aircraft 104, to continuously monitor flight data and parameters during flight. The system 100 may include, without limitation, a computing device 102 that communicates with one or more avionics systems 106 onboard the aircraft 104, at least one server system 114, and air traffic control (ATC) 112, via a data communication network 110. In practice, certain embodiments of the system 100 may include additional or alternative elements and components, as desired for the particular application.

The computing device 102 may be implemented by any computing device that includes at least one processor, some form of memory hardware, a user interface, and communication hardware. For example, the computing device 102 may be implemented using a personal computing device, such as a tablet computer, a laptop computer, a personal digital assistant (PDA), a smartphone, or the like. In this scenario, the computing device 102 is capable of storing, maintaining, and executing an Electronic Flight Bag (EFB) application configured to determine and present emergency alerts when flight constraints may not be satisfied by the current flight of the aircraft 104. In other embodiments, the computing device 102 may be implemented using a computer system onboard the aircraft 104, which is configured to determine and present such emergency alerts.

The aircraft 104 may be any aviation vehicle for which flight constraints and alerts associated with non-compliance with flight constraints are relevant and applicable during completion of a flight route. The aircraft 104 may be implemented as an airplane, helicopter, spacecraft, hovercraft, or the like. The one or more avionics systems 106 may include a Flight Management System (FMS), crew alerting system (CAS) devices, automatic terminal information system (ATIS) devices, Automatic Dependent Surveillance-Broadcast (ADS-B), Controller Pilot Data Link Communication (CPDLC), navigation devices, weather radar, aircraft traffic data, and the like. Data obtained from the one or more avionics systems 106 may include, without limitation: an approved flight plan, an estimated time of arrival, instructions from air traffic control (ATC), Automatic Terminal Information Service (ATIS) data, flight plan restriction data, onboard equipment failure data, aircraft traffic data, weather data, or the like.

The server system 114 may include any number of application servers, and each server may be implemented using any suitable computer. In some embodiments, the server system 114 includes one or more dedicated computers. In some embodiments, the server system 114 includes one or more computers carrying out other functionality in addition to server operations. The server system 114 may store and provide any type of data used to determine compliance and/or non-compliance with constraints associated with the current flight. Such data may include, without limitation: flight plan data, flight plan constraint data, and other data compatible with the computing device 102.

The computing device 102 is usually located onboard the aircraft 104, and the computing device 102 communicates with the server system 114 and air traffic control 112 via a wireless communication connection. The computing device 102 and the server system 114 are generally disparately located, and the computing device 102 and air traffic control 112 are generally disparately located. The computing device 102 communicates with the server system 114 and air traffic control 112 via the data communication network 110 and/or via communication mechanisms onboard the aircraft 104.

The data communication network 110 may be any digital or other communications network capable of transmitting messages or data between devices, systems, or components. In certain embodiments, the data communication network 110 includes a packet switched network that facilitates packet-based data communication, addressing, and data routing. The packet switched network could be, for example, a wide area network, the Internet, or the like. In various embodiments, the data communication network 110 includes any number of public or private data connections, links or network connections supporting any number of communications protocols. The data communication network 110 may include the Internet, for example, or any other network based upon TCP/IP or other conventional protocols. In various embodiments, the data communication network 110 could also incorporate a wireless and/or wired telephone network, such as a cellular communications network for communicating with mobile phones, personal digital assistants, and/or the like. The data communication network 110 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

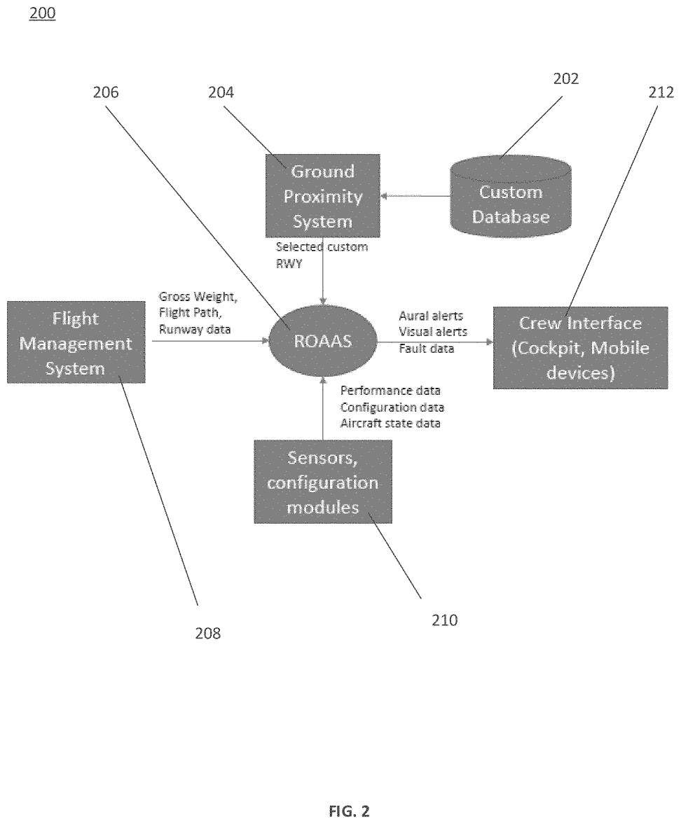

Turning now to FIG. 2, a block diagram 200 is shown of a system for providing runway overrun alerts for custom runways in accordance with one embodiment. The diagram 200 shows various components that feed into the ROAAS 206 including sensors and configuration modules 210, a flight management system (FMS) 208 and various crew interfaces 212 that include both cockpit and mobile device displays such as a primary flight display (PFD). Also included is the custom runway database 202 that is accessed by a ground proximity system (e.g., EGPWF) 204. In some embodiments, the PFD may indicate to the pilot that the aircraft is approaching a custom runway with a graphical symbol, a textual message or both. Additionally, the PFD may show the type of surface (e.g., grass, mud, snow, etc.) for the custom runway with a graphical symbol, a textual message or both. The PFD may also indicate graphically or textual such runway features such as slope, aircraft position, displaces threshold, etc.

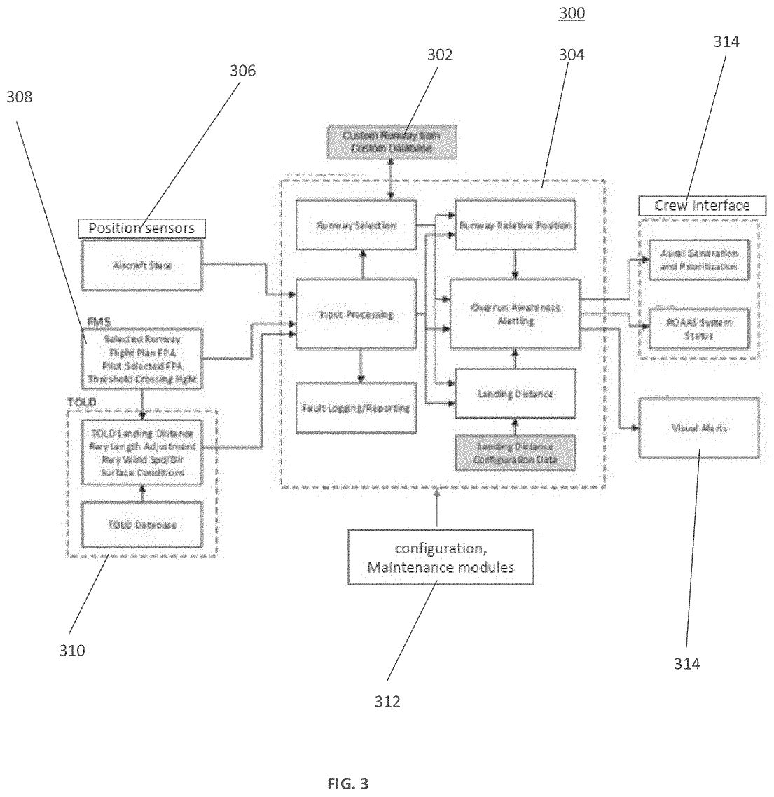

Turning now to FIG. 3, a system architecture diagram 300 is shown of a system for providing runway overrun alerts for custom runways in accordance with one embodiment. In this embodiment, a custom runway database 302 is shown that is accessed by the ROAAS/EGPWF 304. Also, many of the same or similar components are shown that were previously described in FIG. 2. These components include: position sensors 306; an FMS 308; a takeoff/landing system (TOLD) 310; configuration and maintenance modules 312; displays for visual alerts 314; and a crew interface device 314. A crew interface device could be a cockpit display (e.g., PFD), a mobile device, a wearable device, a portable device such as an electronic flight bag (EFB), etc.

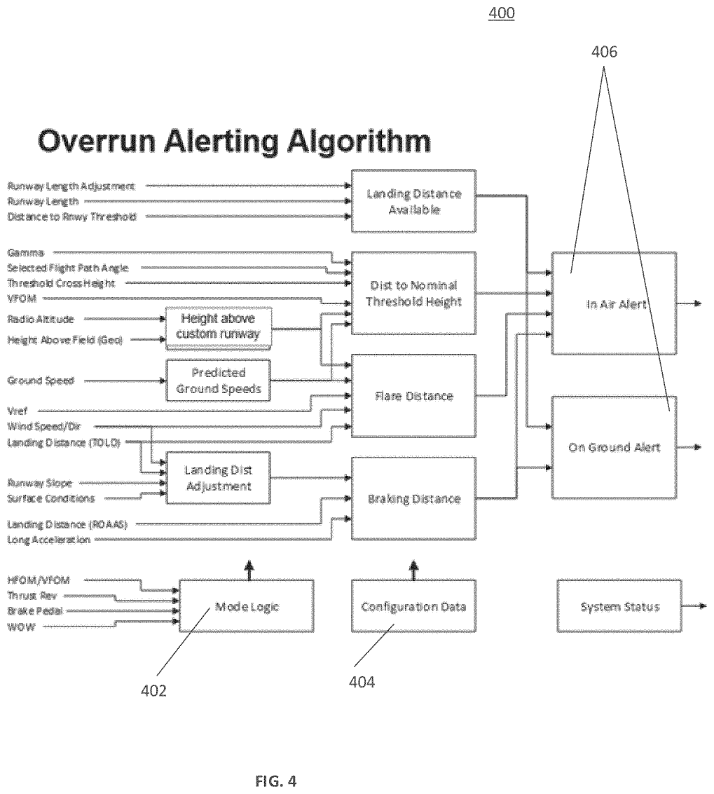

Turning now to FIG. 4, a diagram 400 is shown of an algorithm for a system for providing runway overrun alerts for custom runways in accordance with one embodiment. The algorithm includes standard calculations for the aircraft including landing distance available, distance to nominal threshold height, height above custom runway, predicted ground speeds, flare distance, landing distance adjustment, and braking distance. The algorithm uses mode logic 402 and configurations of the data 404 to determine the system status and if an “in air” or “on ground” alert 406 is required. The type of algorithm shown in this embodiment is commonly used in art to determine if a runway overrun is imminent based on the parameters of the runway.

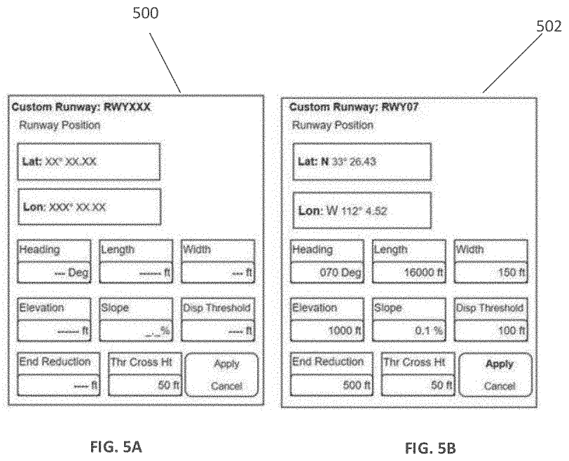

Turning now to FIGS. 5A and 5B, displays are shown for manually entering parameters for a custom runway in accordance with one embodiment. Specifically, FIG. 5A shows a GUI display 500 that allows the entry of the various data parameters of the custom runway. In this display 500, the parameters that may be manually entered by the pilot include: latitude; longitude; heading; length; width; elevation; slope; displacement threshold; end reduction; and threshold cross height. FIG. 5B shows a GUI display 502 with the entered and finalized custom runway data that is ready to be applied and saved to the custom database.

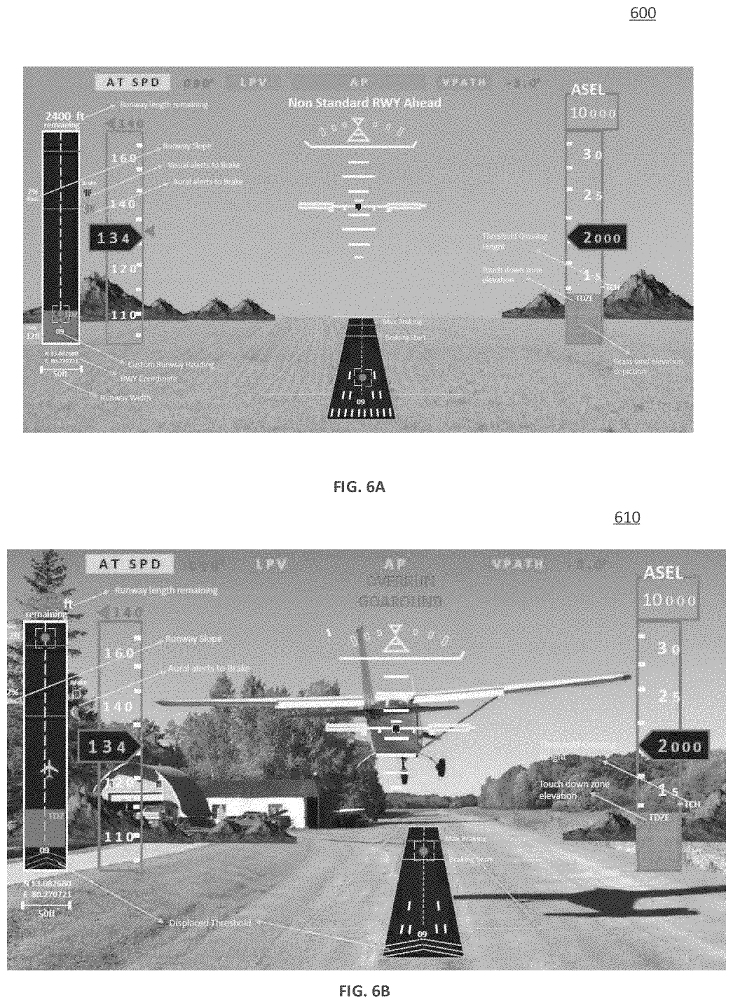

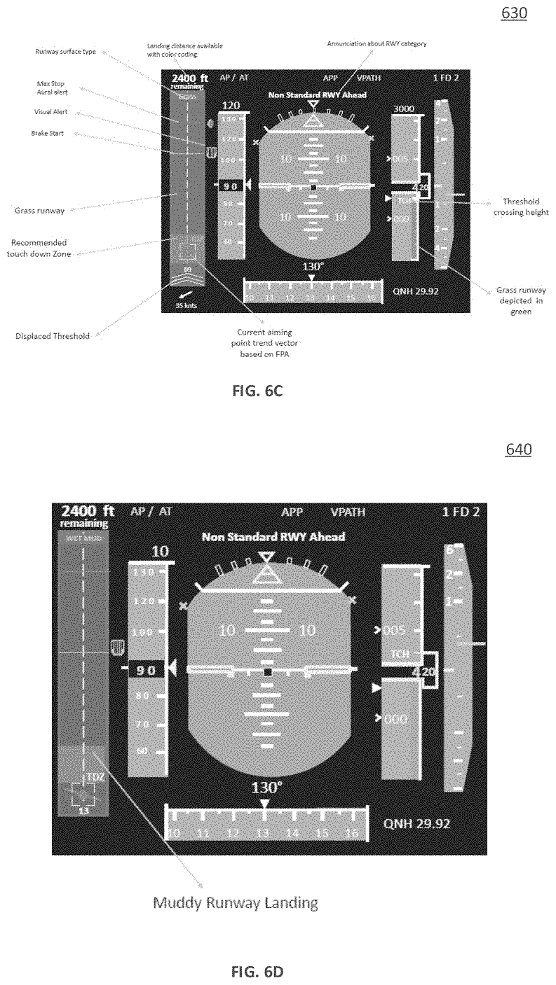

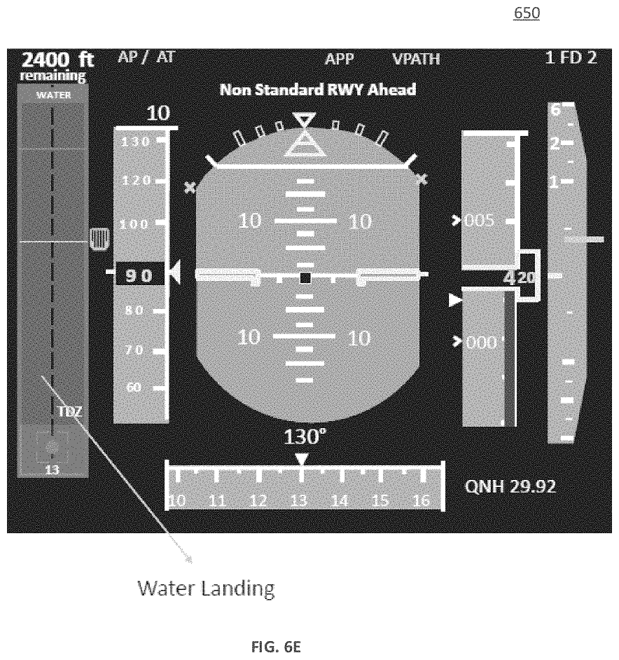

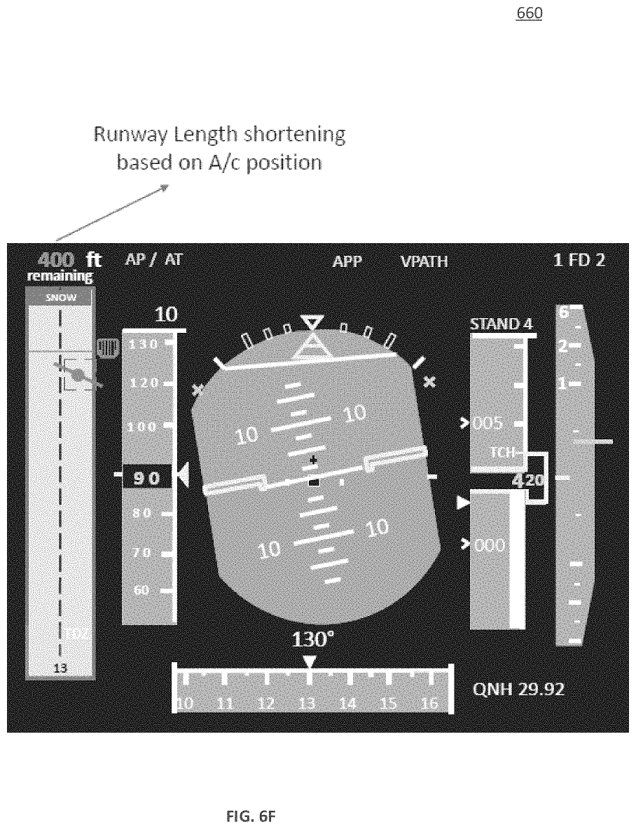

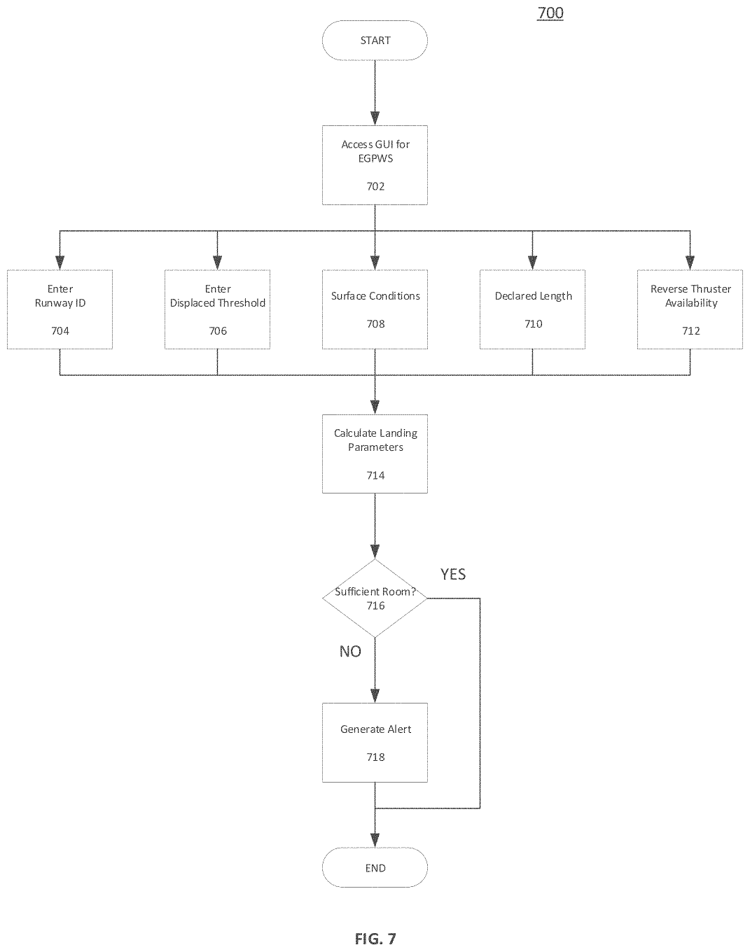

Turning now to FIGS. 6A-6F, various displays are shown for indicating the approach and landing parameters for an aircraft to a custom runway in accordance with one embodiment. These displays show different features of present embodiments as previously described such as notification that the aircraft is approaching a custom runway, the type of surface (e.g., grass, mud, snow, etc.), alerts, slope, aircraft position, displaces threshold, etc. The information may be indicated with a graphical symbol, a textual message or both. Specifically, FIG. 6A shows an example of a display 600 with a textual notice of approach to a non-standard runway. FIG. 6B shows an example of a display 610 with a textual notice of an overrun of the non-standard runway and instructing the pilot to go around. FIG. 6C shows an example of a display 630 with a textual notice of approach to a non-standard runway along with a graphical indication of a grass runway. FIG. 6D shows an example of a display 640 with a textual notice of approach to a non-standard runway along with a graphical indication of a mud runway. FIG. 6E shows an example of a display 650 with a textual notice of approach to a non-standard runway along with a graphical indication of a water runway. Finally, FIG. 6F shows an example of a display 660 with a graphical alert of an overrun of the non-standard runway.

Turning now to FIG. 7, a flowchart 700 is shown depicting a method for providing runway overrun alerts for an aircraft using manually entered parameters for a custom runway in accordance with one embodiment. The method includes accessing a graphical user interface (GUI) for an enhanced ground proximity warning system (EGPWS) 702. The following parameters are then manually entered: identification of the custom runway 704; a displaced threshold of the custom runway 706; surface conditions of the custom runway 708; a declared length of the custom runway 710; and availability of thrust reversers on the aircraft 712. The parameters for the aircraft to safely land and stop on the custom runway are calculated with the EGPWS 714. An alert 718 with the EGPWS is generated if the stopping point of the aircraft is near or beyond the end of the custom runway 716.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for providing runway overrun alerts for an aircraft using manually entered parameters for a non-standard runway, comprising:
accessing an interface for an enhanced ground proximity warning system (EGPWS) and entering necessary data for the non-standard runway necessary to determine the landing parameters to safely land and stop the aircraft;
calculating the landing parameters for the aircraft to safely land and stop on the non-standard runway with the EGPWS; and
generating an alert with the EGPWS if the stopping point of the aircraft is near or beyond the end of the non-standard runway.

2. The method of claim 1, where the non-standard runway is a private use runway.

3. The method of claim 1, where the non-standard runway is a public use runway.

4. The method of claim 1, where the non-standard runway is a seaplane base.

5. The method of claim 1, where the non-standard runway is a grass airfield.

6. The method of claim 1, where the alert is presented graphically in on a display device.

7. The method of claim 1, further comprising:
saving the parameters for the non-standard runway in a custom database.

8. The method of claim 7, where the custom database is cloud based.

9. The method of claim 7, where the custom database is located onboard the aircraft.

10. The method of claim 7, where the custom database is available to a fleet of aircraft.

11. The method of claim 1, where the alert is displayed on a crew interface device.

12. The method of claim 11, where the crew interface device is a mobile electronic device.

13. An apparatus for providing runway overrun alerts for an aircraft using manually entered parameters for a non-standard runway, comprising:
a graphical user interface (GUI) that allows a pilot to access an enhanced ground proximity warning system (EGPWS) and manually enter necessary data for the non-standard runway necessary to determine the landing parameters to safely land and stop the aircraft;
an enhanced ground proximity warning system (EGPWS) that calculates the parameters for the aircraft to safely land and stop on the non-standard runway; and
a primary flight display (PFD) that shows an alert from the EGPWS if the stopping point of the aircraft is near or beyond the end of the non-standard runway.

14. The method of claim 13, where the PFD indicates to the pilot that the aircraft is approaching a non-standard runway along with the calculated landing parameters for the non-standard runway.

15. The method of claim 14, where the PFD indicates to the pilot that the aircraft is approaching a non-standard runway along with the calculated landing parameters with a graphical display.

16. The method of claim 14, where the PFD indicates to the pilot that the aircraft is approaching a non-standard runway along with the calculated landing parameters with a textual message.

17. The method of claim 13, where the PFD shows the type of surface for the non-standard runway.

18. The method of claim 17, where the PFD shows the type of surface for the non-standard runway with graphics.

19. The method of claim 17, where the PFD shows the type of surface for the non-standard runway with a textual message.

20. The method of claim 13, where the PFD shows the runway slope for the non-standard runway with graphics.
